(19) United States
(12) Patent Application Publication
(10) Pub. No.: US 2008/0004553 A1
(43) Pub. Date: Jan. 3, 2008

(54) Massaging Rod

(76) Inventor: Li-Fa Tsai, Taipei (TW)

Correspondence Address: HDSL, 4331 STEVENS BATTLE LANE, FAIRFAX, VA, 22033, US

(21) Appl. No.: 11/428,361

(22) Filed: Jun. 30, 2006

(51) Int. Cl. A61H 15/00

(52) U.S. Cl. 601/120; 601/15; 601/118

(57) ABSTRACT

A massaging rod includes a rolling assembly, two gripping assemblies and several far-infrared ceramic elements. A far-infrared ceramic element is disposed within a rolling element of the rolling assembly. Both ends of the rolling assembly are provided with two sealing elements. The two gripping assemblies are disposed on both ends of the rolling assembly. The gripping assembly is formed of a gripping element, two bearings and a screw rod. The interior of the gripping element is assembled with a far-infrared ceramic element and two bearings. The rod body of the screw rod sequentially penetrates the far-infrared ceramic element and two bearings provided within the gripping element, and then is assembled with the sealing element. A user grips the gripping element by single hand or both hands, so that the rolling element contacts with the human body to perform the rolling massage on the portions of human body being massaged.

### BACKGROUND OF THE INVENTION

1. Field of the Invention

The present invention relates to a massaging rod, and in particular to a massaging rod capable of rolling and massaging on the surface of the skin of human body or clothing.

2. Description of Prior Art

With increased development in the industry and commerce, people continue to work hard so that they often get fatigue. Moreover, some harmful habits in daily life will additionally cause pains to the muscles, nerves, bones, lymphatic system, cardiovascular system and digestive system within the body. At this time, moderate massage can relieve the muscles and bones, make the lymphatic system unobstructed, improve the blood circulation and facilitate the functions of digestive system.

In order to produce a moderate massage, the user often buys a massaging device and massages at home by using this massaging device. FIG. 1 shows a conventional massaging device (Taiwan Patent Publication No. M281619). The structure of the massaging rod disclosed in the drawing has a central rod 4 penetrating through a second massaging rod 5. Two retaining rings 51 are provided on both ends of the central rod 4 and thus connected to both ends of the second massaging rod 5. Then, a bearing 6, a first massaging rod 7, a far-infrared ceramic inner rod 8 and a bearing 9 are sequentially assembled from both ends of the central rod 4. Screwing members 10 are screwed on the threads 41 on both ends of the central rod 4 to prevent the loosening of the above-mentioned components. A gripping block 101 is assembled with one end of the central rod 4 and the first massaging rod 7 to complete the whole assembling of the massaging rod. With this arrangement, the user can grip the massaging rod and perform a rolling massage on the desired portions of his body.

The above massaging rod can provide massage to the desired portion of the user's body. However, after manufacturing or using the massaging rod for a period of time, if any component within the massaging rod is damaged and needs to be detached and repaired, each component should be detached one by one after releasing the screwing member 10 because all the components of the massaging rod are connected on a common central rod 4. Alternatively, after the components on one side (second massaging rod) are detached, the components on the other side of the massaging rod may thus get loosened, which may cause the falling and break down of the far-infrared ceramic inner rod 8. Further, after exchanging the damaged component(s), all the components should be assembled again in order, which causes the waste of time and labor in the repairing, assembling and detaching operations.

### SUMMARY OF THE INVENTION

In view of the above drawbacks, the present invention is to provide a massaging rod in which all the components are not assembled on a common central rod. In the two gripping assemblies on both ends of the massaging rod, if the components on one side need to be repaired or exchanged, only one gripping assembly having the damaged component(s) therein needs to be detached and then exchanged or repaired the damaged component(s). Therefore, when detaching the components of the gripping assembly at one side, the components of the gripping assembly at the other side will not get loosened or drop. As a result, the repairmen or user can detach to repair or exchange the component(s) very easily.

The present invention provides a massaging rod constructed as follows.

A rolling assembly is formed of a rolling element and two sealing elements. The inner walls of both ends of the rolling element are each provided with a first assembling portion. The sealing element has a head thereon. One end of the head is provided with a projecting portion. The surface of the projecting portion has a first connecting portion for connecting to the first assembling portion. A penetrating hole is provided within the head and the projecting portion. The opening of the penetrating hole is provided with a flange. The inner wall of the penetrating hole is provided with a second assembling portion.

Two gripping assemblies are disposed on both ends of the rolling assembly. Each gripping assembly is formed of a gripping element, two bearings and a screw rod. The interior of the gripping element is assembled with the two bearings. The inner wall of one end of the gripping element has a third assembling portion. The screw rod has a head thereon. One end of the head has a projecting portion. A rod body extends from the projecting portion. One end of the rod body has a second connecting portion for connecting to the second assembling portion of the sealing element.

Several far-infrared ceramic elements are provided within the rolling element and the gripping element.

### BRIEF DESCRIPTION OF THE DRAWINGS

FIG. 1 is an exploded view showing the structure of a conventional massaging rod;

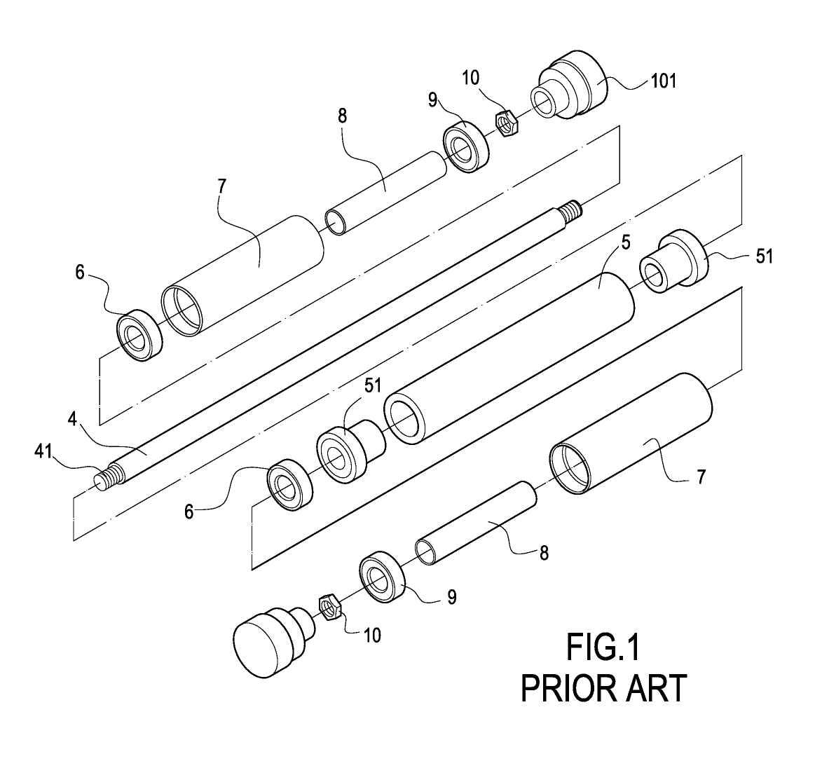

FIG. 2 is an exploded view showing the structure of the massaging rod in accordance with the present invention;

FIG. 3 is a perspective view showing the external appearance of the massaging rod in accordance with the present invention;

FIG. 4 is a cross-sectional view of FIG. 2; and

FIG. 5 is an enlarged cross-sectional view showing a portion of FIG. 4.

### DETAILED DESCRIPTION OF THE INVENTION

The technical contents and detailed description of the present invention will be made with reference to the accompanying drawings.

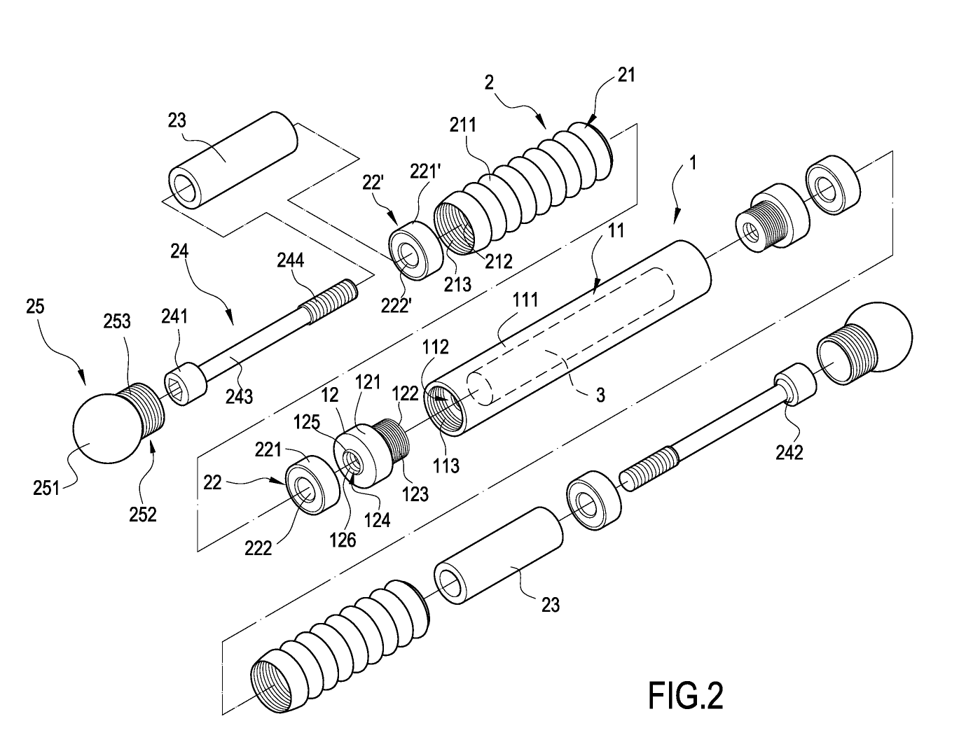

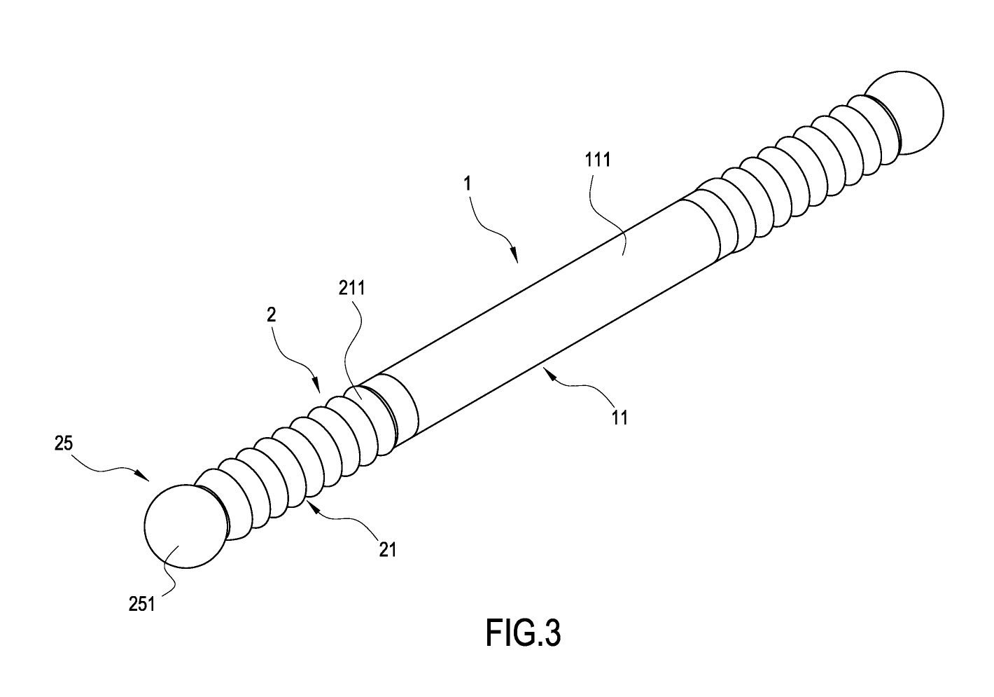

FIG. 2 is an exploded view showing the structure of the massaging rod in accordance with the present invention, and FIG. 3 is a perspective view showing the external appearance of the massaging rod in accordance with the present invention. The massaging rod of the present invention comprises a rolling assembly 1, two gripping assemblies 2 provided on both ends of the rolling assembly 1, and a far-infrared ceramic element 3 provided within the rolling assembly 1. In use, the user grips the gripping assemblies 2 by single hand or both hands, so that the rolling assembly 1 can perform the rolling actions on the human body to achieve the massage. At the same time, the energy emitted by the far-infrared ceramic element 3 within the rolling assembly 1 can perform a physical therapy on the portions of the human body being massaged.

The rolling assembly 1 is formed of a rolling element 11 and two sealing elements 12. The rolling element 11 is a hollow tubular body 111 having an accommodating space 112 therein for accommodating the far-infrared ceramic element 3. The inner walls of the tubular body 111 on both ends of the accommodating space 112 is each provided with a first assembling portion 113 for connecting to the sealing element 12. In the present invention, the first assembling portion 113 is a thread. The sealing element 12 has a head 121 thereon. One end of the head 121 is provided with a projecting portion 122 having a diameter smaller than that of the head 121. The surface of the projecting portion 122 has a first connecting portion 123 for connecting to the first assembling portion 113. In the present invention, the first connecting portion 123 is a thread. A penetrating hole 124 is provided within the head 12 and the projecting portion 122. The opening of the penetrating hole 124 is provided with a flange 125. In the present invention, the flange 125 is formed into a conical shape. The inner wall of the penetrating hole 124 is provided with a second assembling portion 126. In the present invention, the second assembling portion 126 is a thread.

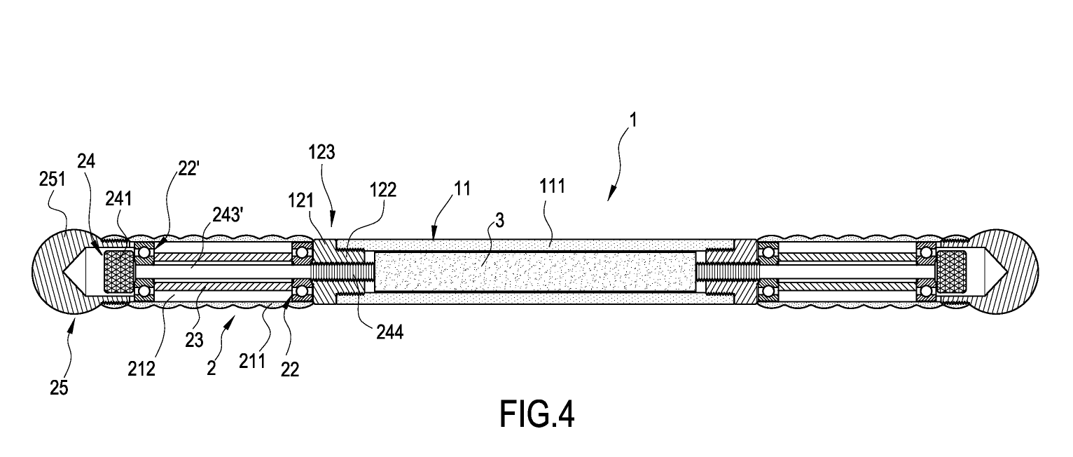

The two gripping assemblies 2 are provided on both ends of the rolling assembly 1. Each gripping assembly 2 is formed of a gripping element 21, two bearings 22 and 22′, a far-infrared ceramic element 23, a screw rod and a sealing element 25. The gripping element 21 is a tubular body. The surface of the gripping element has a gripping face 211 formed into a continuous wave, and the interior thereof has a penetrating space 212. The inner wall of the gripping element 21 provided on one end of the penetrating space 212 has a third assembling portion 213. In the present invention, the third assembling portion 213 is a thread. The two bearings 22, 22′ each has an outer ring 221, 221′ and an inner ring 222, 222′. Rolling beads 223, 223′ are sealed into the space between the outer ring 221, 221′ and the inner ring 222, 222′ (as shown in FIG. 4). The outer ring 221, 221′ abuts against and thus is assembled with the inner wall of the penetrating space 212. After the two bearings 22 and 22′ have been disposed in the gripping element 21, a hollow-tubular far-infrared ceramic element 23 is disposed between the penetrating space 212 of the gripping element 21 and the two bearings 22, 22′. After the two bearings 22 and 22′ and the far-infrared ceramic element 23 are disposed in the gripping element 21, a screw rod 24 penetrates through the two bearings 22, 22′ and the far-infrared ceramic element 23 and is assembled with the sealing element 12. The screw rod 24 has a head 241 thereon. One end of the head 241 has a conical projecting portion 242. A rod body 243 extends from the projecting portion 242. One end of the rod body 243 has a second connecting portion 244. In the present embodiment, the second connecting portion 244 is a thread. After the rod body 243 of the screw rod 24 penetrates through the two bearings 22, 22′ and the far-infrared ceramic element 23 and further the second connecting portion 244 is connected to the second connecting portion 126 of the sealing element 12, the flange 125 of the sealing element 12 abuts against one side of the inner ring 222 of the bearing 22 while the projecting portion 242 of the screw rod 24 abuts against one side of the inner ring 222′ of the bearing 22′. As a result, the two bearings 22, 22′ and the screw rod 24 will not get loosened. After the gripping element 21, the two bearings 22, 22′, the far-infrared ceramic element 23 and the screw rod 24 are assembled with the rolling assembly 1, a sealing element 25 is connected to one end of the gripping element 21. The sealing element 25 can be provided with a decorating portion 251 for decorating the external appearance of the massaging rod. A projecting portion 252 extends from one end of the decorating portion 251. The surface of the projecting portion 252 is provided with a third connecting portion 253. The third connecting portion 253 is connected to the third assembling portion 213 within one end of the gripping element 21. In the present embodiment, the third connecting portion 253 is a thread.

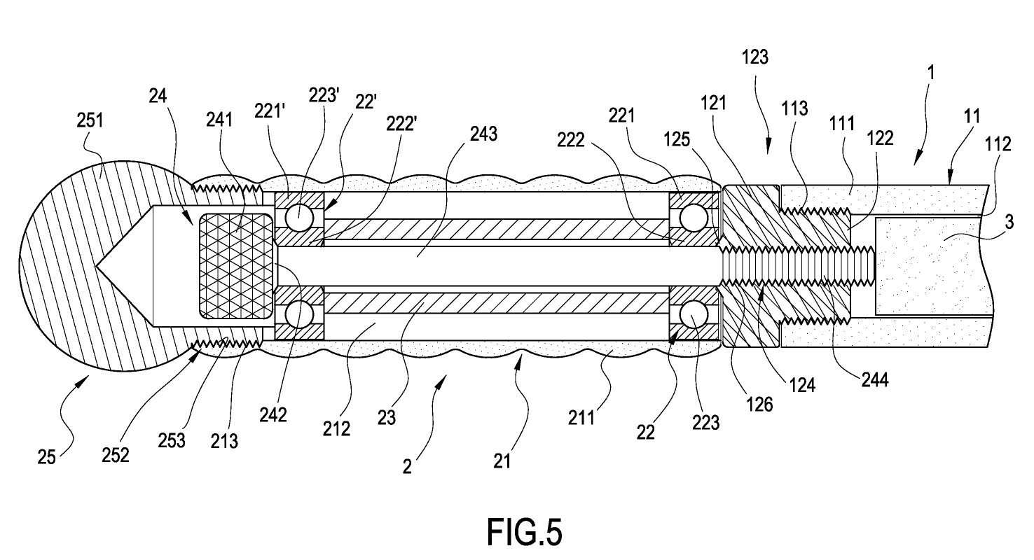

FIG. 4 is a cross-sectional view of FIG. 2, and FIG. 5 is an enlarged cross-sectional view showing a portion of FIG. 4. During the assembly of the present invention, the far-infrared ceramic element 3 is first disposed into the accommodating space 112 of the rolling element 11, and then the first connecting portion 123 of the sealing element 12 is connected to the first assembling portion 113 of the rolling element 11, thereby to seal the far-infrared ceramic element 3 within the rolling element 11. Next, another far-infrared ceramic element 23 is disposed in the gripping element 21, and then two bearings 22, 22′ are tightly assembled in the penetrating space 212 of the gripping element 21 and positioned on both ends of the far-infrared ceramic element 23. After one screw rod 24 subsequently penetrates the two bearings 22, 22′ and the far-infrared ceramic element 23, the second connecting portion 244 on the rod body 243 is connected to the second assembling portion 126 of the sealing element 12. As a result, the flange 123 of the sealing element 12 and the projecting portion 242 of the screw rod 24 abut against one side of the inner ring 222, 222′ of the bearing 22, 22′, respectively. Finally, the third connecting portion 253 of the sealing element 25 is assembled with the third assembling portion 213 within one end of the gripping element 21, thereby to complete the assembly of the entire massaging rod.

When using the massaging rod, the user grips the gripping face 221 of the gripping element 21 by single hand or both hands, the continuously waved profile of the gripping face 211 is suitable to be gripped by the palm of the user and thus can achieve a slide-proof effect. When the user grips the gripping element 21, since the flange 125 of the sealing element 12 and the projecting portion 242 of the screw rod 24 abut against one side of the inner ring 222, 222′ of the two bearings 22, 22′ respectively, the rolling element 11 drives the sealing element 12 and the screw rod 24 to cause the rotation of the inner ring 222, 222′ of the bearing 22, 22′ when the rolling element 11 is rolling on the human body. Therefore, the rolling element 11 can rotate smoothly on the human body.

When the user grips the massaging rod to perform the massage on the human body, the far-infrared ceramic elements 3, 23 provided within the rolling element 11 and the gripping element 21 can emit infrared energy to simultaneously perform the physical therapy on the portions being massaged.

Further, in manufacturing or using the massaging rod of the present invention, if any of the rolling assembly 1, the gripping assembly 2 and the far-infrared ceramic element 3 is damaged, only one gripping assembly 2 having the damaged component(s) therein needs to be detached and then exchanged or repaired the damaged component(s). It is unnecessary to detach the entire massaging rod to exchange or repair the damaged component(s). Therefore, it is much easier and timesaving to perform the repairing or exchanging operation.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A massaging rod, comprising:
a rolling assembly including a rolling element and two sealing elements, an inner wall on each of both ends of the rolling element provided with a first assembling portion, the sealing element having a first connecting portion thereon for connecting to the first assembling portion, the sealing element provided with a second assembling portion therein; and
two gripping assemblies disposed on both ends of the rolling assembly, respectively, each gripping assembly including a gripping element, two bearings and a screw rod, an inner wall of the gripping element having a third assembling portion, the two bearings disposed in an interior of the gripping element, the screw rod provided with a second connecting portion, the second connecting portion connected to the second assembling portion of the sealing element after the screw rod penetrating the two bearings.

2. The massaging rod according to claim 1, wherein the rolling element is a hollow tubular body with an accommodating space formed therein.

3. The massaging rod according to claim 2, wherein the accommodating space is provided with a far-infrared ceramic element.

4. The massaging rod according to claim 1, wherein each of the two bearings is provided with an outer ring and an inner ring, rolling beads are provided between the outer ring and the inner ring, the outer ring abuts against and thus is assembled with an inner wall of a penetrating space.

5. The massaging rod according to claim 1, wherein the sealing element has a head thereon, a projecting portion projects from one end of the head, a surface of the projecting portion has a third connecting portion, a penetrating hole is provided within the head and the projecting portion, an opening of the penetrating hole is provided with a flange for abutting against an inner ring of the bearing, an inner wall of the penetrating hole is provided with the second assembling portion.

6. The massaging rod according to claim 5, wherein the flange is formed into a conical shape.

7. The massaging rod according to claim 1, wherein the gripping element is a tubular body having a penetrating space therein and a gripping face formed into a continuous wave.

8. The massaging rod according to claim 1, wherein a hollow tubular far-infrared ceramic element is provided between a penetrating space of the gripping element and the two bearings.

9. The massaging rod according to claim 1, wherein the screw rod has a head thereon, one end of the head is provided with a projecting portion, a rod body extends from the projecting portion, one end of the rod body has the second connecting portion.

10. The massaging rod according to claim 9, wherein the projecting portion on one end of the head of the screw rod is formed into a conical shape.

11. The massaging rod according to claim 1, wherein the first, second, third assembling portions and the first, second connecting portions are threads.

12. The massaging rod according to claim 1, wherein the sealing element is connected to one end of the gripping element, the sealing element has a decorating portion thereon, a projecting portion extends from one end of the decorating portion, a surface of the projecting portion is provided with a third connecting portion, the third connecting portion is assembled with the third assembling portion within one end of the gripping element.

13. The massaging rod according to claim 12, wherein the third connecting portion is a thread.
